(19) United States
(12) Patent Application Publication
(10) Pub. No.: US 2024/0257596 A1
(43) Pub. Date: Aug. 1, 2024

(54) MEDIUM HANDLING DEVICE

(71) Applicant: Oki Electric Industry Co., Ltd., Tokyo (JP)

(72) Inventors: Ippei KAMATA, Tokyo (JP); Katsuyoshi TOMIZAWA, Tokyo (JP); Kazuhiro MIKI, Tokyo (JP)

(73) Assignee: Oki Electric Industry Co., Ltd., Tokyo (JP)

(21) Appl. No.: 18/566,513

(22) PCT Filed: May 18, 2022
(86) PCT No.: PCT/JP2022/020720

§ 371 Date: Dec. 1, 2023

(30) Foreign Application Priority Data
Jun. 15, 2021 (JP) 2021-099780

(51) Int. Cl. G07D 11/18; B65H 29/60; B65H 29/62; B65H 31/24; G07D 11/25

(52) U.S. Cl. CPC G07D 11/18; B65H 29/60; B65H 29/62; B65H 31/24; G07D 11/25

(57) ABSTRACT

In a banknote pay-in/pay-out device of an automated teller machine, in movement processing, banknotes being stored in a movement origin banknote storage are conveyed to a pay-in/pay-out section, then the banknotes are recognized by a recognition section while being conveyed by a conveyance section to a temporary holding section, and normal banknotes are conveyed to the movement destination banknote storage and stored therein. Due thereto, the banknote pay-in/pay-out device is able to move the banknotes being stored in the movement origin banknote storage to the movement destination banknote storage, and, in such case, is able to recognize a denomination, level of damage, and the like, of each of the banknotes once again by performing recognition processing using the recognition section, and is able to count the total number of medium being stored once again.

### TECHNICAL FIELD

The present disclosure relates to a medium handling device and is, for example, appropriately applied to an automatic teller machine (ATM) that performs a desired transaction when a medium such as a banknote or the like is introduced by a customer.

### BACKGROUND ART

Hitherto, automated teller machines and the like employed in financial institutions etc. have become widely prevalent as machines to, for example, let a customer pay-in cash such as banknotes and coins etc. and to pay-out cash to the customer according to content of a transaction with the customer. There is a proposal for an automated teller machine including: for example, a control section that performs overall control; a banknote pay-in/pay-out section that performs exchange of banknotes (a medium) with a customer, a conveyance section that conveys introduced banknotes; a recognition section that recognizes the denomination, authenticity, and the like of banknotes; a temporary holding section that temporarily holds banknotes; and plural banknote storages (medium storages) that store banknotes by denomination.

Moreover, there is a proposal for an automated teller machine that shortens a conveyance path as much as possible by disposing each section so as to be connected to a conveyance section configured with a substantially straight line shape conveyance path, thereby shortening the processing time and achieving a reduction in the frequency of obstruction occurrence (see, for example, Japanese Patent Application Laid-Open (JP-A) No. 2015-200163 (FIG. 2 and the like)).

### SUMMARY OF INVENTION

### Technical Problem

In an automated teller machine configured as described above, sometimes there is a desire to perform movement processing to move banknotes from one banknote storage to another banknote storage according to the wishes of a financial institution or the like. Such movement processing needs an operation to feed out and convey a banknote from a banknote storage that is the movement origin and, after the denomination, condition, and the like of the banknote have been recognized in a recognition section, to convey the banknote to the banknote storage that is the conveyance destination, and store the banknote therein.

However, in the automated teller machine configured as described in JP-A No. 2015-200163, due to the structure of the conveyance section, a path is not able to be formed to convey a banknote that has been fed out from one banknote storage to another banknote storage after the banknote has been recognized by the recognition section, and movement processing by continuous operation is unable to be performed.

The present disclosure provides a medium handling device enabling movement processing of a medium to be performed between plural banknote storages.

### Solution to Problem

A first aspect of the present disclosure is a medium handling device including: an input/output section that inputs and outputs paper leaf-shaped mediums; a first conveyance section, connected to the input/output section, that conveys the mediums; a recognition section, provided to the first conveyance section, that recognizes the conveyed mediums; a second conveyance section, connected to the first conveyance section through a connection section, that conveys the medium plural medium storages connected to the second conveyance section, that store reusable mediums; and a control section that utilizes recognition results of the recognition section to control a conveyance path of the mediums configured by the first conveyance section, the connection section, and the second conveyance section, wherein, in movement processing that moves a medium being stored in a medium storage as a movement origin, to the medium storage as a movement destination, the control section controls so as to: convey mediums fed out from the medium storage to the input/output section, store the mediums in the input/output section, feed out the mediums from the input/output section and convey by the first conveyance section, acquire a respective recognition result for each medium, using the recognition section and convey each medium to one of the medium storages according to the recognition result.

In the first aspect of the present disclosure, when performing movement processing, the medium handling device, conveys the medium from the movement origin medium storage to the pay-in/pay-out section and stores it therein, then feeds out the medium from the pay-in/pay-out section, and after being recognized in the recognition section, moves the medium to the movement destination medium storage. Accordingly, in the first aspect of the present disclosure, the medium handling device may move the medium stored in the movement origin medium storage to the movement destination medium storage, and may obtain recognition results for the medium.

### Advantageous Effects of the Invention

According to the above aspect, the medium handling device of the present disclosure may execute movement processing of the medium between plural banknote storages.

### BRIEF DESCRIPTION OF DRAWINGS

FIG. 1 is a schematic perspective view illustrating a configuration of an automated teller machine.

FIG. 2 is a schematic line diagram illustrating a configuration of a banknote pay-in/pay-out device according to a first exemplary embodiment.

FIG. 3 is a schematic line diagram illustrating a configuration of a conveyance section.

FIG. 4 is a schematic line diagram illustrating a banknote conveyance path in pay-in count processing according to the first exemplary embodiment.

FIG. 5 is a schematic line diagram illustrating a banknote conveyance path in pay-in storage processing according to the first exemplary embodiment.

FIG. 6 is a schematic line diagram illustrating a banknote conveyance path in pay-out processing according to the first exemplary embodiment.

FIG. 7 is a schematic line diagram illustrating a configuration of a banknote pay-in/pay-out device according to a second exemplary embodiment.

FIG. 8 is a schematic line diagram illustrating a banknote conveyance path in pay-in processing according to the second exemplary embodiment.

FIG. 9 is a schematic line diagram illustrating a banknote conveyance path in pay-out processing according to the second exemplary embodiment.

### DESCRIPTION OF EMBODIMENTS

Description follows regarding exemplary embodiments to implement the invention (hereafter referred to as exemplary embodiments), with reference to the drawings. [1. First Exemplary Embodiment]

[1-1. Automated Teller Machine and Banknote Pay-In/Pay-Out Device Configuration]

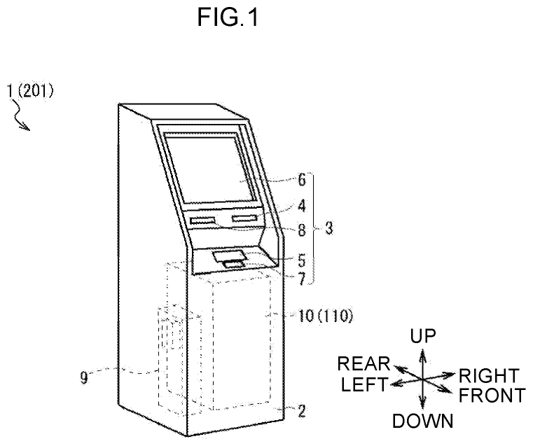

As in the external appearance illustrated in FIG. 1, an automated teller machine 1 configured around a box shaped case 2 is for example installed in a financial institution or the like, and performs transactions with a user (namely a customer of the financial institution or the like) related to cash, such as pay-in processing and pay-out processing.

The case 2 is provided with a customer interface section 3 at a location where inserting banknotes and operation using a touch panel etc. is easy in a state in which a user faces the front side of the case 2. The customer interface section 3 performs direct exchange of cash, cards, etc. with a user (customer), as well as performing notification of information related to transactions and receiving operation instructions. The customer interface section 3 is provided with a card insertion/removal port 4, a pay-in/pay-out port 5, an operation and display section 6, a ten-key 7, and a receipt issue port 8.

The card insertion/removal port 4 is a part where various cards such as cash cards are inserted or dispensed. A card processing section (non-illustrated) is provided at a far side of the card insertion/removal port 4 for performing reading of an account number or the like magnetically recorded on the various cards. The pay-in/pay-out port 5 is where banknotes for paying in are introduced by a user and from where banknotes for paying out to the user are dispensed. The pay-in/pay-out port 5 is opened or closed by driving a shutter. Banknotes are, for example, formed in paper leaf-shapes from rectangular shaped paper.

The operation and display section 6 is configured by touch panel resulting from a liquid crystal display (LCD) for displaying an operation screen during a transaction being integrated together with a touch sensor for selecting a type of transaction and entering a PIN number, a transaction amount, and the like. The ten-key 7 is physical keys for receiving entry of numbers from “0” to “9” etc., and is employed during an operation to enter the PIN number, transaction amount, and the like. The receipt issue port 8 is a part that issues a receipt printed with transaction content and the like at the end of transaction processing. A receipt processing section (not illustrated in the drawings) that prints transaction content and the like on a receipt is provided at the far side of the receipt issue port 8.

In the following description, a side of the automated teller machine 1 facing a user is defined as being a front side, an opposite side thereto is defined as being a rear side, left and right as seen by a user facing the front side are defined as being a left side and a right side, and furthermore an upper side and a lower side are defined thereby.

A main control section 9 that performs general control of the overall automated teller machine 1, a banknote pay-in/pay-out device 10 that performs various processing relating to banknotes, and the like are provided inside the case 2. The main control section 9 is configured around a Central Processing Unit (CPU), not illustrated in the drawings, and reads and executes specific programs from a non-illustrated read only memory (ROM), flash memory, or the like so as to perform various processing such as pay-in processing and pay-out processing. The main control section 9 is provided internally with a storage section configured from random access memory (RAM), a hard disk drive, flash memory, or the like, and various information is stored in this storage section.

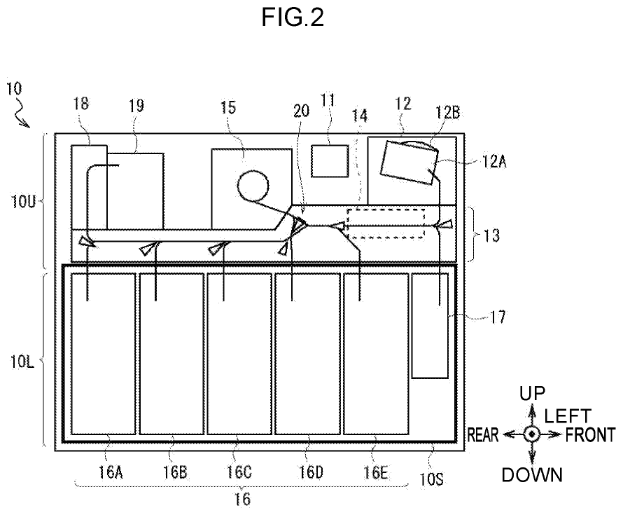

The banknote pay-in/pay-out device 10 incorporates plural parts internally to perform various processing related to banknotes serving as a medium, as illustrated in side view in FIG. 2. The banknote pay-in/pay-out device 10 is configured split broadly into an upper section unit 10U occupying a portion further to the upper side than an up-down direction approximate center, and a lower section unit 10L occupying a portion at a lower side thereof. For case of explanation, the automated teller machine 1 or the banknote pay-in/pay-out device 10 will be referred to below as a medium handling device.

The upper section unit 10U is provided with a banknote control section 11 that performs general overall control, a pay-in/pay-out section 12 that exchanges banknotes with a user, a conveyance section 13 and an upper conveyance section 18 that convey banknotes to the respective sections, a recognition section 14 that recognizes banknotes, a temporary holding section 15 that temporarily stores banknotes, and an upper storage 19 that stores banknotes.

Similarly to the main control section 9, the banknote control section 11 is configured around a non-illustrated CPU, and reads and executes specific programs from non-illustrated ROM, flash memory, or the like so as to perform various processing such as processing to decide conveyance destinations of the banknotes, and processing to control operation of the respective sections. The banknote control section 11 is provided internally with a storage section including RAM, flash memory, or the like, and this storage section is stored with various information, and various information is read from this storage section.

The pay-in/pay-out section 12 is positioned at a front upper portion inside the upper section unit 10U. The pay-in/pay-out section 12 is provided internally with an internal receptacle 12A that houses banknotes received from a user, that houses banknotes for delivery to a user, and that can be opened and closed by a shutter 12B above. Plural banknotes are housed inside the receptacle 12A in a state stacked with their sheet faces facing the front-rear direction. The pay-in/pay-out section 12 separates banknotes inside the receptacle 12A and delivers them one at a time to the conveyance section 13, and also discharges banknotes received from the conveyance section 13 into the receptacle 12A and stacks them therein.

The conveyance section 13 is positioned inside the upper section unit 10U at a lower end portion thereof, and is formed overall thin in the up-down direction, with an elongated shape along the front-rear direction. A conveyance guide to guide banknotes and multiple rotating rollers and the like (not illustrated in the drawings) are disposed as appropriate inside the conveyance section 13, and a straight line shaped conveyance path is formed so as to convey banknotes substantially along the front-rear direction, with a direction of their short edges along a direction of progression thereof.

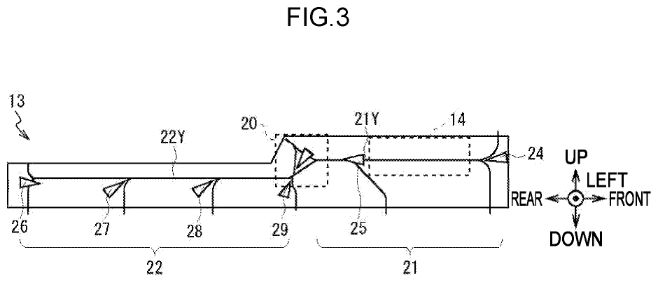

As illustrated in the enlarged diagram of FIG. 3, the conveyance section 13 is configured broadly split into a temporary holding switching section 20 disposed in the vicinity of a center thereof, and a front conveyance section 21 and a rear conveyance section 22 respectively disposed on the front side and on the rear side of the temporary holding switching section 20. Namely, the temporary holding switching section 20 connects the front conveyance section 21 and the rear conveyance section 22 together. The temporary holding switching section 20 will be referred to as a connection section below. The temporary holding switching section 20 is controlled by the banknote control section 11 so as to switch the conveyance path of the banknotes so as to convey banknotes between the front conveyance section 21, the rear conveyance section 22, and the temporary holding section 15.

A reject switching section 24, the recognition section 14, and a switching section 25 are arranged in a straight line in this sequence from the front side inside the front conveyance section 21 serving as a first conveyance section, and a substantially straight line shaped front conveyance path 21Y is formed thereby along the front-rear direction. Switching sections 26, 27, 28, and 29 are arranged inside the rear conveyance section 22 along a substantially straight line in this sequence from the rear side, and a substantially straight line shaped rear conveyance path 22Y is formed thereby along the front-rear direction. Each of the switching sections appropriately switch the conveyance path of banknotes under control of the banknote control section 11. The front conveyance section 21 and the rear conveyance section 22 each accumulate several banknotes within their respective conveyance paths.

The recognition section 14 is incorporated in the front conveyance section 21 and is positioned on the banknote conveyance path between the pay-in/pay-out section 12 and the temporary holding switching section 20. The recognition section 14 internally incorporates plural types of sensor, these being a thickness sensor, an image sensor, and a magnetic sensor, acquires various information from the banknote being conveyed, and based on this recognizes the denomination, authenticity, condition (whether or not damage is present), and the like of the banknote, and notifies the recognition results to the banknote control section 11.

The temporary holding section 15 (FIG. 2) adopts a so-called tape escrow method, and stores banknotes by wrapping the banknotes against a circumferential side face of a circular cylinder shaped drum together with a tape, and feeds out the banknotes by peeling the banknotes together with the tape away from the circumferential side face. In the above case, the temporary holding section 15 feeds the banknotes out in the reverse order to when storing.

The upper conveyance section 18 is disposed at a rear end vicinity at an upper side of the conveyance section 13, and conveys banknotes from a lower end toward an upper section front side. The upper storage 19 serving as a first medium storage is provided at a location toward the rear at an upper side of the conveyance section 13, and is positioned adjacent to the front side of the upper conveyance section 18. The upper storage 19 receives banknotes conveyed by the upper conveyance section 18 and stores them internally.

The upper storage 19 is employed, for example, as a counterfeit note storage to store banknotes determined in the recognition section 14 to be counterfeit notes (forged banknotes) distinctly from other banknotes, as a reject box to store reject banknotes (described later), or as a left-behind storage and the like to store banknotes from the pay-in/pay-out section 12 that were left behind by a user.

The lower section unit 10L has all peripheral side faces covered by a toughened safe case 10S. There are five individual banknote storages 16 and a reject box 17 provided inside the toughened safe case 10S, from the rear side toward the front side.

The lower section unit 10L is provided with a loading section (not illustrated in the drawings) formed with plural slots for loading from above the banknote storages 16 and the reject box 17, and this loading section is attached to the safe case 10S through specific slide rails (not illustrated in the drawings). Thus, in the lower section unit 10L, the banknote storages 16 and the reject box 17 can be attached to and detached from the loading section in a state in which the loading section has been slid in the front-rear direction and pulled outside the safe case 10S.

The banknote storages 16 serving as medium storages are formed in cuboidal shapes long in the up-down direction, and each includes an internal space in which banknotes are stacked and stored. The denomination of the banknotes that should be stored in each of the respective banknote storages 16 is pre-set. The banknote storages 16 receive banknotes from the conveyance section 13 and stack and store the banknotes internally. When an instruction to feed out banknotes has been received from the banknote control section 11, the banknote storages 16 separate and feed out the stacked banknote one at a time and deliver them to the conveyance section 13.

The reject box 17 is formed in a cuboidal shape that is long in the up-down direction, and includes an internal space in which banknotes are stacked and stored. The reject box 17 internally stores banknotes that are banknotes determined by the recognition section 14 and the banknote control section 11 to be unsuitable for reuse with a high level of damage (hereafter referred to as reject banknotes or reject medium) when they arrive conveyed in by the conveyance section 13.

[1-2. Banknote Pay-In/Pay-Out Device Processing]

In the automated teller machine 1, the banknote pay-in/pay-out device 10 performs pay-in processing (hereafter also sometimes referred to as take-in processing) when a pay-in transaction is performed with a user. In the automated teller machine 1, the banknote pay-in/pay-out device 10 performs pay-out processing (hereafter also sometimes referred to as dispensing processing) when a pay-out transaction is performed with a user.

Furthermore, in the banknote pay-in/pay-out device 10, movement processing is performed to move banknotes from a given banknote storage 16 to another banknote storage 16 based on operational instructions from an employee of a financial institution or a maintenance worker, or the like (hereafter referred to as a user). Description follows regarding each of pay-in processing, pay-out processing, and movement processing in the banknote pay-in/pay-out device 10.

[1-2-1. Pay-In Processing]

In pay-in processing, under control of the banknote control section 11 the banknote pay-in/pay-out device 10 (FIG. 2) first performs pay-in count processing to count the number of paid in banknotes while recognizing the denomination and the like of the banknotes, and next performs pay-in storage processing to convey the banknotes to the appropriate storage location and store the banknotes therein.

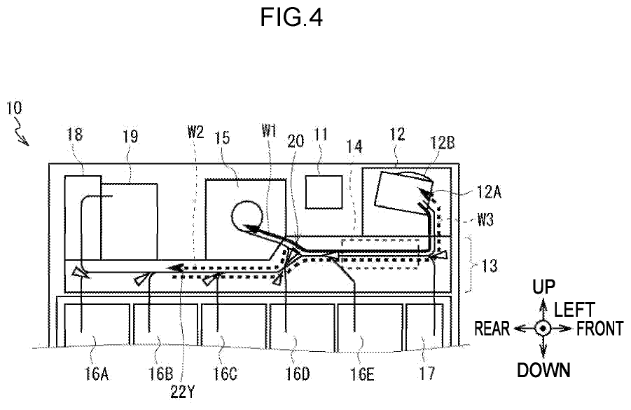

More specifically when, for example, the banknote control section 11 receives operational input by instruction to start a pay-in transaction from a user via the operation and display section 6 (FIG. 1), the banknote control section 11 starts the pay-in count processing, and conveys the banknotes along the conveyance path as illustrated by arrow W1 in FIG. 4.

The pay-in/pay-out section 12 first opens the shutter 12B, banknotes are introduced into the receptacle 12A by a user, the shutter 12B is closed and the banknotes are separated and taken in one at a time, and delivered in sequence to the conveyance section 13. While the banknotes received from the pay-in/pay-out section 12 by the conveyance section 13 are being sequentially conveyed rearward by the front conveyance section 21, each of the banknotes is sequentially recognized using the recognition section 14, and then sequentially delivered to the temporary holding switching section 20. In the above case, the recognition section 14 sends the obtained recognition results to the banknote control section 11.

Based on the acquired recognition results, the banknote control section 11 determines each of the banknotes to be a pay-in receipt banknote when determined receivable and able to continue to subsequent processing, or to be a pay-in reject banknote when determined not receivable and should be returned for the time being to the user. Furthermore, for pay-in receipt banknotes, the banknote control section 11 decides banknotes reusable banknotes with a comparatively light level of damage to have a final conveyance destination of the respective banknote storage 16 by denomination, and decides reject banknotes not suitable for reuse with a comparatively heavy level of damage to have a final conveyance destination of the reject box 17, and stores these final conveyance destinations.

Then according to the determination results of the banknotes delivered from the front conveyance section 21 to the temporary holding switching section 20, for any pay-in receipt banknotes the banknote control section 11 conveys these banknotes to the temporary holding section 15 along a continuation of arrow W1, and stores the banknotes therein. Moreover, for any pay-in reject banknotes, the banknote control section 11 causes these banknotes to progress into the rear conveyance section 22 along arrow W2, and accumulates these banknotes inside the rear conveyance path 22Y.

Thus when taking in is finished for all of the banknotes from the receptacle 12A of the pay-in/pay-out section 12, the banknote control section 11 returns any pay-in reject banknotes accumulated in the rear conveyance path 22Y of the rear conveyance section 22 to the user. More specifically, the banknote control section 11 conveys the pay-in reject banknotes in the rear conveyance path 22Y along the arrow W3 to the pay-in/pay-out section 12, and opens the shutter 12B and the like so as to let them be taken by the user. Then the user confirms the state of the banknotes taken from the receptacle 12A and, when appropriate, re-introduces these banknotes to the pay-in/pay-out section 12. The above cycle of processing is repeated by the banknote control section 11 when a banknote is re-introduced into the pay-in/pay-out section 12. However, when there are no pay-in reject banknotes accumulated inside the rear conveyance path 22Y of the rear conveyance section 22, then the banknote control section 11 ends the pay-in count processing.

In such cases the banknote control section 11 calculates a pay-in amount based on the denominations of the banknotes introduced into the pay-in/pay-out section 12 and the banknote tally result, and also displays a specific operation instruction screen on the operation and display section 6 (FIG. 1), presents this pay-in amount to the user and also gets the user to select whether or not to continue with the pay-in transaction. In a case in which cancelation of the pay-in transaction is instructed by the user, the banknote control section 11 uses the conveyance section 13 to convey all of the banknotes held in the temporary holding section 15 to the pay-in/pay-out section 12, and returns the banknotes to the user.

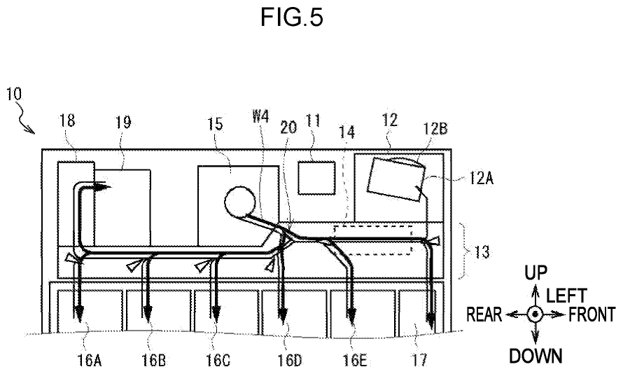

However, in a case in which continuation of the pay-in transaction is instructed by the user, the banknote control section 11 starts the pay-in storage processing. More specifically, the banknote control section 11 first starts feed-out processing in the temporary holding section 15, sequentially feeds out the stored banknotes (pay-in receipt banknotes), and delivers the banknotes to the temporary holding switching section 20 as illustrated by arrow W4 in FIG. 5.

In the above case, based on stored content, the banknote control section 11 switches the banknote conveyance path in the temporary holding switching section 20 and each of the switching sections as appropriate according to the conveyance destination of each of the banknotes as decided in the pay-in count processing, and conveys each of the banknotes to the respective conveyance destination and stores the banknote thereat. The banknote control section 11 thereby classifies normal reusable banknotes by denomination and stores them in the respective banknote storages 16 (16A to 16E), and stores reject banknotes unsuitable for reuse in the reject storage 17.

[1-2-2. Pay-Out Processing]

In pay-out processing, the banknote pay-in/pay-out device 10 (FIG. 2) pays out banknotes according to a pay-out amount instructed by the user under control of the banknote control section 11. More specifically, the banknote control section 11 first receives a specific operational input including the pay-out amount from the user through the operation and display section 6 (FIG. 1), and decides the denomination and count of banknotes according to the pay-out amount.

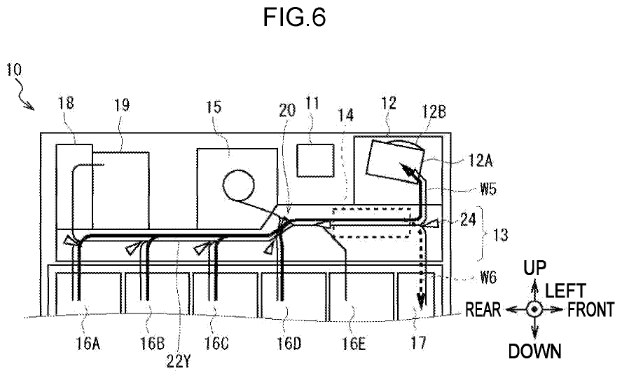

Next the banknote control section 11 sequentially feeds out the banknotes stored in each of the banknote storages 16 according to the decided denominations and counts, and sequentially delivers the banknotes to the conveyance section 13. The conveyance section 13 uses the recognition section 14 to recognize the banknotes progressing forward in the front conveyance section 21 as illustrated by arrow W5 in FIG. 6, and sends the recognition result to the banknote control section 11.

The banknote control section 11 controls so as to switch the reject switching section 24 according to the banknote recognition result, and when there is no problem with the banknotes they are progressed to the pay-in/pay-out section 12 as illustrated by arrow W5 and stored therein. However, when these banknotes are reject banknotes or double fed, the banknotes are progressed to and stored in the reject box 17 as illustrated by arrow W6. Then when conveying has finished for all of the banknotes corresponding to the pay-out amount to the pay-in/pay-out section 12, the banknote control section 11 opens the shutter 12B and the like and lets the banknotes be taken out by the user. [1-2-3. Movement Processing]

When movement processing is performed, the banknote pay-in/pay-out device 10 (FIG. 2) is instructed by operation from the user, through the operation and display section 6 (FIG. 1) respectively, instructing a movement origin banknote storage that is to be the movement origin of the banknote, and a movement destination banknote storage that is to be the movement destination of the banknote. In the banknote pay-in/pay-out device 10 the banknote storages 16A to 16D are specifiable as the movement origin, and the banknote storages 16A to 16E and the upper storage 19 are specifiable as the movement destination. Description follows regarding an example of a case in which the movement origin banknote storage is the banknote storage 16A, and the movement destination banknote storage is the banknote storage 16D.

Moreover in the movement processing, the banknote pay-in/pay-out device 10 also sequentially performs three stages of processing under control of the banknote control section 11, these being movement feed-out processing, movement recognition processing, and movement storage processing. The movement feed-out processing at an early stage is processing to convey the banknotes from the movement origin banknote storage to the pay-in/pay-out section 12. The movement recognition processing at a middle stage is processing to convey the banknotes from the pay-in/pay-out section 12 to the temporary holding section 15 and to perform recognition processing thereon in the recognition section 14. The movement storage processing at a later stage is processing to convey the banknotes from the temporary holding section 15 to the movement destination banknote storage and store the banknotes therein.

Specifically, in the early stage movement feed-out processing, the banknote control section 11 performs processing so as to convey banknotes along arrow W5, similarly to in pay-out processing (FIG. 6). More specifically, the movement origin banknote storage (banknote storage 16A) feeds out banknotes one at a time and delivers them to the conveyance section 13. The conveyance section 13 conveys the received banknotes and delivers them to the pay-in/pay-out section 12. The pay-in/pay-out section 12 houses the received banknotes in the receptacle 12A. In the above case, the recognition section 14 does not perform recognition processing on the banknotes conveyed by the conveyance section 13.

Next, in the middle stage movement recognition processing, the banknote control section 11 performs processing so as to convey banknotes along arrow W1, substantially similar to in the pay-in count processing (FIG. 4). Specifically, the pay-in/pay-out section 12 separates the banknotes inside the receptacle 12A and delivers them one at a time to the conveyance section 13. The conveyance section 13 conveys the banknotes to the temporary holding section 15. In the above case, the recognition section 14 performs recognition processing on the conveyed banknotes, similarly to in the pay-in count processing, and sends the obtained recognition results to the banknote control section 11. Based on the obtained recognition results, for a normal banknote the banknote control section 11 stores the conveyance destination thereof with a movement destination banknote storage, and for a reject banknote stores the conveyance destination thereof with the reject box 17.

Furthermore, in the later stage movement storage processing, the banknote control section 11 performs processing so as to convey banknotes along arrow W4, similarly to in the pay-in storage processing (FIG. 5). Specifically, the temporary holding section 15 feeds out banknotes one at a time and delivers them to the conveyance section 13. The conveyance section 13 switches the temporary holding switching section 20 under control of the banknote control section 11, and for normal banknotes conveys them to the movement destination banknote storage (banknote storage 16D) and stores them therein, and for reject banknotes conveys them to the reject box 17 and stores them therein.

In a case in which the count of banknotes stored in the movement origin banknote storage is a maximum count that can be stored in the receptacle 12A of the pay-in/pay-out section 12 (for example 200 notes) or greater, the banknote control section 11 moves all of the banknotes stored in the movement origin banknote storage by splitting into plural batches and repeating the movement processing for each batch of the maximum count.

After this, the banknote control section 11 displays a specific message that means movement processing is complete, and the count of banknotes and the like that have been respectively moved to the movement destination banknote storages and the reject box 17 is displayed on the operation and display section 6 (FIG. 1), the user is notified that the movement processing has been completed, and the movement processing is ended.

[1-3. Effects etc.]

In the banknote pay-in/pay-out device 10 of the automated teller machine 1 according to the first exemplary embodiment configured as described above, in the movement processing, the banknotes being stored in the movement origin banknote storage are conveyed to the pay-in/pay-out section 12, and next these banknotes are recognized by the recognition section 14 while being conveyed by the conveyance section 13 to the temporary holding section 15, and normal banknotes are conveyed to the movement destination banknote storage and stored therein.

This means that the banknote pay-in/pay-out device 10 is able to move the banknotes being stored in the movement origin banknote storage to the movement destination banknote storage, and also, in such case, is able to once again recognize the denomination, level of damage, and the like of each of the banknotes by performing recognition processing using the recognition section 14, enabling the total count of banknotes stored to be tallied once again.

As viewed from another perspective, the banknote pay-in/pay-out device 10 has a compact device configuration with a shortened conveyance path, and so the conveyance section 13 is formed in a single straight line shape substantially along the front-rear direction, in a form in which the banknote storages 16 etc. are connected through the switching devices, and with the recognition section 14 provided in the conveyance section 13.

Thus for processing executed with a comparatively high frequency in the banknote pay-in/pay-out device 10, such as pay-in processing and pay-out processing, the conveyance distance for the banknotes is comparatively short, enabling a reduction to be realized in the frequency of obstructions occurring commensurate with the shortening of the processing time and the shortening of the conveyance distance. However, processing executed with a comparatively low frequency in the banknote pay-in/pay-out device 10, such as banknote movement processing, is able to be executed by utilizing the pay-in/pay-out section 12 and the temporary holding section 15, albeit this takes a comparatively long time due to the comparatively complicated conveyance paths.

Namely, the banknote pay-in/pay-out device 10 may shorten waiting time and reduce obstruction occurrence frequency in requests of a priority user such as a customer of a financial institution, whereas for a relatively low priority user such as an employee of a financial institution or a maintenance worker, may automatically perform banknote movement processing while taking some time therefore.

Moreover the banknote pay-in/pay-out device 10 is configured so as to, in the movement processing, perform equivalent processing to that of part of the pay-out processing (FIG. 6) in the early stage movement feed-out processing, perform equivalent processing to that of part of the pay-in count processing (FIG. 4) of the middle stage movement recognition processing, and perform equivalent processing to that of part of the pay-in storage processing (FIG. 5) of the later stage movement storage processing. This means that, in the banknote pay-in/pay-out device 10, there is no need for special control to be performed in the banknote control section 11 for the movement processing alone, and instead it is sufficient to perform similar control to that of the pay-out processing, pay-in count processing, and the pay-in storage processing which are executed as basic processing.

Looking at this from another perspective, in the banknote pay-in/pay-out device 10 the shape, the placement, and the like of each section is designed so as to be able to execute the pay-out processing, the pay-in count processing, and the pay-in storage processing, which are basic processing, as smoothly as possible. The banknote pay-in/pay-out device 10 accordingly effectively utilizes the pay-out processing, the pay-in count processing, and the pay-in storage processing in the movement processing so as to convey banknotes along similar paths to in each processing, enabling smoothly execution thereof. Namely, the banknote pay-in/pay-out device 10 does not, for example, cause banknote blockages to occur due to forming unnatural conveyance paths.

According to the above configuration, in the movement processing, the banknote pay-in/pay-out device 10 of the automated teller machine 1 conveys banknotes stored in the movement origin banknote storage to the pay-in/pay-out section 12, then next uses the recognition section 14 to recognize the banknotes while being conveyed to the temporary holding section 15 using the conveyance section 13, and conveys normal banknotes therein to the movement destination banknote storage and stores them therein. Due thereto, the banknote pay-in/pay-out device 10 is able to move the banknotes being stored in the movement origin banknote storage to the movement destination banknote storage, and, in such case, is able to recognize a denomination, level of damage, and the like, of each of the banknotes once again by performing recognition processing using the recognition section 14, and is able to count the total number of medium being stored once again.

### 2. Second Exemplary Embodiment

An automated teller machine 201 of a second exemplary embodiment differs from the automated teller machine 1 according to the first exemplary embodiment (FIG. 1) in that the second exemplary embodiment includes a banknote pay-in/pay-out device 210 instead of the banknote pay-in/pay-out device 10, however other points are configured similarly to the first exemplary embodiment.

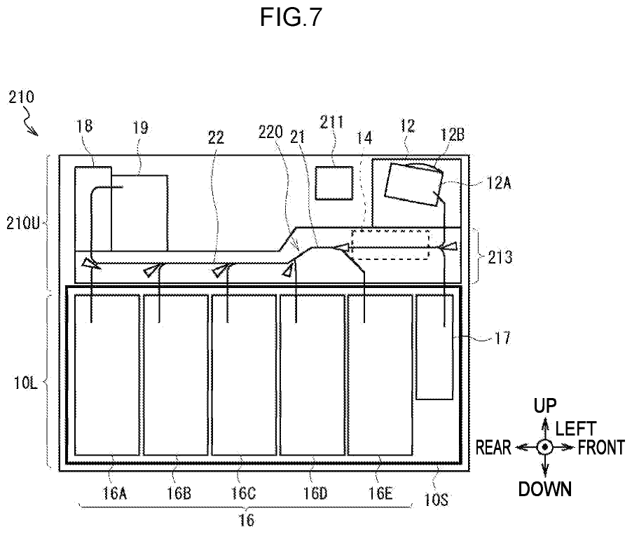

As illustrated in FIG. 7 corresponding to FIG. 2, the banknote pay-in/pay-out device 210 differs from the banknote pay-in/pay-out device 10 according to the first exemplary embodiment in that it includes an upper section unit 210U instead of the upper section unit 10U, however it is configured similarly thereto in the lower section unit 10L. The upper section unit 210U differs from upper section unit 10U (FIG. 2) in that it includes a banknote control section 211 and a conveyance section 213 instead of the banknote control section 11 and the conveyance section 13, and in that it lacks the temporary holding section 15, however other points are configured similarly thereto.

Similarly to the banknote control section 11 (FIG. 2), the banknote control section 211 is also configured around a non-illustrated CPU, and reads and executes specific programs from non-illustrated ROM, flash memory, or the like so as to perform processing that partly differs from that of the banknote control section 11. The banknote control section 211 also, similarly to the banknote control section 11, includes an internal storage section to store various information. The conveyance section 213 is configured with the front conveyance section 21 and the rear conveyance section 22 connected together with a connection section 220 instead of by the temporary holding switching section 20 of the conveyance section 13 (FIG. 2 and FIG. 3).

[2-1. Banknote Pay-In/Pay-Out Device Processing]

The banknote pay-in/pay-out device 210 has different processing operations of the pay-in processing and the movement processing due to the temporary holding section 15 being omitted, compared to the banknote pay-in/pay-out device 10 according to the first exemplary embodiment. Description follows regarding each processing contained in the pay-out processing. In the banknote pay-in/pay-out device 210, reject banknotes may be stored in the upper storage 19 in addition to in the reject box 17.

[2-1-1. Pay-In Processing]

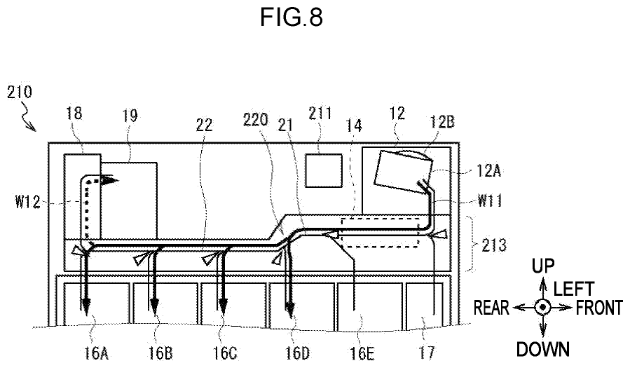

In pay-in processing, the banknote pay-in/pay-out device 210 differs from the first exemplary embodiment in that counting of banknotes is performed together with storing as a single cycle of processing, under control of the banknote control section 211. More specifically, for example, the banknote control section 211 starts the pay-in processing and conveys banknotes along the conveyance path as illustrated by arrow W11 in FIG. 8 when an operational input to start a pay-in transaction is received from a user through the operation and display section 6 (FIG. 1).

First when banknotes are introduced into the receptacle 12A by a user, the pay-in/pay-out section 12 separates these and takes them in one at a time, and sequentially delivers them to the conveyance section 13. Each of the banknotes is sequentially recognized by the recognition section 14 while the conveyance section 13 is conveying the banknotes received from the pay-in/pay-out section 12 sequentially rearward using the front conveyance section 21, and sends the obtained recognition results therefrom to the banknote control section 211.

Based on the acquired recognition results, for each of the banknotes the banknote control section 211 determines the banknote to be a pay-in receipt banknote when determined receivable and able to continue to subsequent processing, or to be a pay-in reject banknote when determined not receivable and should be temporarily returned to the user.

Furthermore, for pay-in receipt banknotes the banknote control section 211 decides the final conveyance destination to be the respective banknote storage 16 by denomination for reusable banknotes having a comparatively light level of damage, and to be the upper storage 19 for reject banknotes not suitable for reuse having a comparatively heavy level of damage, and controls the conveyance section 213. Then, while appropriately switching the conveyance path of banknotes in each switching section under control of the banknote control section 211, the conveyance section 213 then conveys normal banknotes to the respective banknote storage 16 along arrow W11 and stores them therein, and conveys reject banknotes to the upper storage 19 along arrow W12 and stores them therein.

When a pay-in reject banknote has occurred, the banknote control section 211 temporarily stops conveying the banknote and reverses the conveyance direction thereof, so as to immediately return the pay-in reject banknote to the pay-in/pay-out section 12.

[2-1-2. Pay-Out Processing]

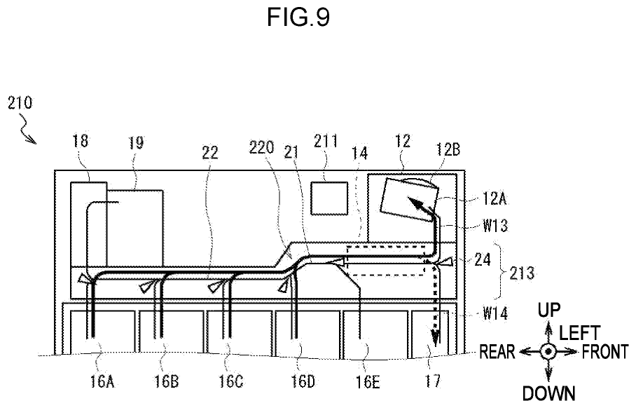

In pay-out processing, the banknote pay-in/pay-out device 210 (FIG. 7) conveys and pays out banknotes similarly to in the first exemplary embodiment under control of the banknote control section 211. Namely, the banknote pay-in/pay-out device 210 sequentially feeds out the banknotes stored in each of the banknote storages 16 according to the denominations and counts of the banknotes that are to be paid out, and sequentially delivers the banknotes to the conveyance section 213. The conveyance section 213 progresses the banknotes forward in the front conveyance section 21 as illustrated by arrow W13 in FIG. 9, the banknotes are recognized by the recognition section 14, and the recognition results are sent to the banknote control section 211.

The banknote control section 211 controls so as to switch the reject switching section 24 according to the banknote recognition result, and as long as there is no problem with the banknotes, causes the banknotes to progress to the pay-in/pay-out section 12 as illustrated by arrow W13 and stores them therein. However, in a case in which banknotes are reject banknotes or have been double fed, causes the banknotes to progress to the reject box 17 as illustrated by arrow W14 and stores them therein. Then, when conveying of all of the banknotes corresponding to the pay-out amount to the pay-in/pay-out section 12 has finished, the banknote control section 211 opens the shutter 12B and the like and lets the banknotes be taken out by the user.

[2-1-3. Movement Processing]

In movement processing, the banknote pay-in/pay-out device 210 (FIG. 7) moves the banknotes under control of the banknote control section 211 by processing partly different to that of the first exemplary embodiment. Specifically, the banknote control section 211 sequentially performs two stages of processing, these being movement feed-out processing and movement storage processing. Description follows regarding an example of a case in which, similarly to in the first exemplary embodiment, the movement origin banknote storage is the banknote storages 16A, and the movement destination banknote storage is the banknote storage 16D.

At the early stage movement feed-out processing, the banknote control section 211 performs processing so as to convey banknotes along arrow W13, similarly in pay-out processing (FIG. 9). More specifically, the movement origin banknote storage (banknote storages 16A) feeds out banknotes one at a time and delivers them to the conveyance section 213. The conveyance section 213 conveys the received banknotes and delivers them to the pay-in/pay-out section 12. The pay-in/pay-out section 12 houses the received banknotes in the receptacle 12A. During the above, the recognition section 14 does not perform recognition processing on the banknotes being conveyed by the conveyance section 213.

Next in the later stage movement storage processing, the banknote control section 11 performs processing substantially similar to in pay-in processing (FIG. 8), so as to convey banknotes along arrow W11 and arrow W12. More specifically, the pay-in/pay-out section 12 separates out the banknotes in the receptacle 12A one at a time and delivers them to the conveyance section 213. The conveyance section 213 conveys the banknotes rearward, the banknotes are recognized by the recognition section 14, and the obtained recognition results are sent to the banknote control section 211.

In the above case, the banknote control section 211 controls the conveyance section 213 based on the obtained recognition results, such that the conveyance destination for normal banknotes is the movement destination banknote storage, and such that the conveyance destination for reject banknotes is the upper storage 19. The conveyance section 213 switches the conveyance path of the banknotes at each of the switching devices under control of the banknote control section 211, and, in such case, conveys normal banknotes along arrow W11 to the movement destination banknote storage (banknote storage 16D) and stores them therein, and conveys reject banknotes along arrow W12 to the upper storage 19 and stores them therein.

[2-2. Effects etc.]

In movement processing of the configuration described above, the banknote pay-in/pay-out device 210 of the automated teller machine 201 according to the second exemplary embodiment conveys the banknotes being stored in the movement origin banknote storage to the pay-in/pay-out section 12, these banknotes are next recognized by the recognition section 14 while being conveyed by the conveyance section 213, and normal banknotes are conveyed to the movement destination banknote storage and stored therein.

This means that, similarly to in the first exemplary embodiment, the banknote pay-in/pay-out device 210 is able to move the banknotes being stored in the movement origin banknote storage to the movement destination banknote storage, and, in such case, is able to recognize a denomination, level of damage, and the like, of each of the banknotes once again by performing recognition processing using the recognition section 14, and is able to count the total number of medium being stored once again.

Moreover in the movement processing, the banknote pay-in/pay-out device 210 is configured so as to perform processing equivalent to part of the pay-out processing (FIG. 9) in the early stage movement feed-out processing, and to perform processing equivalent to part of the pay-in processing (FIG. 8) in the later stage movement storage processing. This means that similarly to in the first exemplary embodiment, in the banknote pay-in/pay-out device 210 there is no need to perform special control for the movement processing alone in the banknote control section 211, and instead it is sufficient to perform similar control to the pay-out processing and pay-in processing being executed as basic processing.

From the other points too, the banknote pay-in/pay-out device 210 according to the second exemplary embodiment may also exhibit similar operation and advantageous effects to the banknote pay-in/pay-out device 10 according to the first exemplary embodiment.

### 3. Other Exemplary Embodiments

Note that in the first exemplary embodiment described above, a case in which, in the early stage movement feed-out processing of the movement processing, the recognition processing is not performed when the banknotes are passing the recognition section 14, and the recognition processing is performed in the middle stage movement recognition processing, has been described. However the present disclosure is not limited thereto and, for example, in the early stage movement feed-out processing the recognition processing may be performed when the banknotes are passing the recognition section 14, and the obtained recognition results may be stored. Similar applies to the second exemplary embodiment.

In the first exemplary embodiment described above, a case in which the movement origin banknote storage in the movement processing is one out of the banknote storages 16A to 16D, has been described. However, the present disclosure is not limited thereto and, for example, a configuration may be adopted such that the banknote storage 16E is also specifiable as the movement origin banknote storage. In a case in which the banknote storage 16E is the movement origin banknote storage, in the early stage movement feed-out processing, for example, a banknote that has been fed out from the banknote storage 16E may be conveyed to the temporary holding section 15 and temporary stored therein, and then this banknote may be fed out from the temporary holding section 15 and conveyed to the pay-in/pay-out section 12. Similarly in the second exemplary embodiment, in this case, a banknote may, for example, be temporary stored in one out of the banknote storages 16A to 16D instead of in the temporary holding section 15, and then fed out therefrom and conveyed to the pay-in/pay-out section 12.

Furthermore, in the first exemplary embodiment described above, a case in which various information is acquired from the banknotes in the recognition section 14 using plural types of sensor, and the denomination, authenticity, condition, the like of the banknotes is recognized based on this information, and the recognition results obtained thereby notified to the banknote control section 11, has been described. However, the present disclosure is not limited thereto and, for example, various information obtained from the banknotes in the recognition section 14 using plural types of sensor may itself be notified to the banknote control section 11, and the denomination and the like of each of the banknotes recognized in the banknote control section 11 based on this information. Similar applies to the second exemplary embodiment.

Furthermore, in the first exemplary embodiment described above, a case in which, when a pay-in reject banknote has occurred in the pay-in processing, these banknotes are accumulated in the rear conveyance path 22Y, and these pay-in reject banknotes conveyed to the pay-in/pay-out section 12 and returned to the user after finishing taking in all the banknotes from the receptacle 12A (FIG. 4), has been described. However, the present disclosure is not limited thereto and, for example, each time a pay-in reject banknote occurs in the pay-in processing, the banknote may be conveyed in reverse so as to be returned to the pay-in/pay-out section 12.

Furthermore, in the first exemplary embodiment described above, a case in which the temporary holding section 15 is configured by a tape escrow method, and stores banknotes against a circumferential side face of a circular cylinder shaped drum by wrapping the banknotes together with a tape, has been described. However, the present disclosure is not limited thereto and, for example, a configuration may be adopted in which banknotes are temporarily stored by various methods such as a method of storing by stacking banknotes similarly to in the banknote storages 16. In such cases, the plural banknotes may be fed out either in the same order or the reverse order to when the plural banknotes were received.

Furthermore, in the first exemplary embodiment described above, a case in which there are four individual banknote storages 16 (16A to 16D) connected to the rear conveyance section 22 (FIG. 2), has been described. However, the present disclosure is not limited thereto, and three or less individual banknote storages 16 or five or more thereof may be connected thereto. Similar applies to the second exemplary embodiment.

Furthermore, in the first exemplary embodiment described above, a case in which the upper conveyance section 18 and the single individual upper storage 19 are connected to the rear conveyance section 22 (FIG. 2), has been described. However, the present disclosure is not limited thereto and, for example, a specific switching device may be provided to the upper conveyance section 18 and two or more individual upper storages connected, or the upper conveyance section 18 and the upper storage 19 may be omitted. Similar applies to the second exemplary embodiment.

In the first exemplary embodiment described above, a case in which there is the single individual banknote storage 16 (16E) connected to the front conveyance section 21 (FIG. 2), has been described. However, the present disclosure is not limited thereto and, for example, two or more individual banknote storages 16 may be connected to the front conveyance section 21, or a configuration may be adopted in which there is no banknote storage 16 connected to the front conveyance section 21. Similar applies to the second exemplary embodiment.

Furthermore, in the first exemplary embodiment described above, a case in which the single reject box 17 is connected to the front conveyance section 21 (FIG. 2), has been described. However, the present disclosure is not limited thereto and, for example, a reject box may be provided so as to be connected to the rear conveyance section 22, either instead of the reject box 17 or in addition thereto, or alternatively the reject box 17 may be omitted and the upper storage 19 caused to function as a reject box. Similar applies to the second exemplary embodiment.

Furthermore, in the first exemplary embodiment described above, a case in which the banknote control section 11 of the banknote pay-in/pay-out device 10 (FIG. 2) controls each processing of the banknotes, such as the movement processing and the like, has been described. However, the present disclosure is not limited thereto and, for example, each processing of the movement processing and the like may be controlled by the banknote control section 11 in cooperation with the main control section 9 (FIG. 1). Similar applies to the second exemplary embodiment.

Furthermore, in the first exemplary embodiment described above, a case in which the present disclosure is applied to the banknote pay-in/pay-out device 10 of the automated teller machine 1 that performs transaction processing related to banknotes as a medium, with a customer, has been described. However, the present disclosure is not limited thereto and, for example, the present disclosure may be applied to various devices that handle various paper leaf-shaped media as the transaction target, such as various types of cash vouchers and securities or the like, or entrance tickets and travel tickets. Similar applies to the second exemplary embodiment.

Furthermore, the present disclosure is not limited to each of the exemplary embodiments described and the other exemplary embodiments. Namely, an applicable range of the present disclosure also encompasses exemplary embodiments resulting from freely combining part or all of the exemplary embodiments described above and the other exemplary embodiments described above, and exemplary embodiments resulting from extracting part thereof.

Furthermore, in the exemplary embodiment described above, a case in which the banknote pay-in/pay-out device 10 serving as a medium handling device is configured by the pay-in/pay-out section 12 serving as an input/output section, the front conveyance section 21 serving as a first conveyance section, the recognition section 14 serving as a recognition section, the rear conveyance section 22 serving as a second conveyance section, the banknote storages 16 serve as medium storages, and the banknote control section 11 serving as a control section, has been described. However, the present disclosure is not limited thereto and a medium processing device may be configured by an input/output section, a first conveyance section, a recognition section, a second conveyance section, a medium storage, and a control section that have various other configurations.

### INDUSTRIAL APPLICABILITY

The present disclosure may, for example, be utilized in a banknote pay-in/pay-out device incorporated into an automated teller machine that performs a pay-in transaction and a pay-out transaction related to banknotes with a user.

The entire content of the disclosure of Japanese Patent Application No. 2021-099780 filed on Jun. 15, 2021 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A medium handling device comprising:
an input/output section that inputs and outputs paper leaf-shaped mediums;
a first conveyance section, connected to the input/output section, that conveys the mediums;
a recognition section, provided to the first conveyance section, that recognizes the conveyed mediums;
a second conveyance section, connected to the first conveyance section through a connection section, that conveys the mediums;
a plurality of medium storages connected to the second conveyance section, that store reusable mediums; and
a control section that utilizes recognition results of the recognition section to control a conveyance path of the mediums configured by the first conveyance section, the connection section, and the second conveyance section,
wherein, in movement processing that moves a medium being stored in a medium storage as a movement origin, to the medium storage as a movement destination, the control section controls so as to:
convey mediums fed out from the medium storage to the input/output section,
store the mediums in the input/output section,
feed out the mediums from the input/output section and convey by the first conveyance section,
acquire a respective recognition result for each medium, using the recognition section and
convey each medium to one of the medium storages according to the recognition result.

2. The medium handling device of claim 1, further comprising a temporary holding section that temporarily stores mediums and feeds out the mediums either in a same order or in a reverse order relative to when the mediums were stored, wherein:
the connection section is configured by a temporary holding switching section that switches the conveyance path of the mediums between the first conveyance section, the second conveyance section, and the temporary holding section; and
in the movement processing, the control section controls so as to:
convey, by the first conveyance section, the mediums fed out from the input/output section and stored in the temporary holding section,
acquire and store the respective recognition result for each medium using the recognition section, and
convey the mediums that have been fed out from the temporary holding section to one of the medium storages according to the recognition result stored for each medium.

3. The medium handling device of claim 1, wherein, in the movement processing, the control section controls so as to:
convey the mediums fed out from the input/output section by the first conveyance section,
acquire the respective recognition result using the recognition section for each of the mediums, and
convey the medium to one of the medium storages according to the recognition result.

4. The medium handling device of claim 1, wherein:
in take-in processing to take in mediums from outside, the control section controls so as to:
introduce the mediums into the input/output section,
feed out the mediums from the input/output section to the first conveyance section,
convey the mediums by the first conveyance section,
acquire the respective recognition result for each medium using the recognition section, and
convey the mediums to one of the medium storages according to the recognition result;
in dispensing processing to dispense the medium outside, the control section controls so as to:
feed out the mediums from the medium storage to the second conveyance section,
convey the mediums to the input/output section by the second conveyance section and the first conveyance section, and
dispense the mediums from the input/output section; and
in the movement processing, the control section controls so as to:
after the medium has been conveyed from the medium storage, which is the movement origin, to the input/output section by processing equivalent to part of the dispensing processing, convey the medium to the medium storage, which is the movement destination, by processing equivalent to part of the take-in processing.

5. The medium handling device of claim 1, further comprising a first medium storage connected to the first conveyance section, that stores reusable mediums,
wherein, in the movement processing, the control section controls so as to convey the medium according to the recognition result to one out of the medium storage or the first medium storage.

6. The medium handling device of claim 1, further comprising a reject box connected to the first conveyance section, that stores rejected mediums that are mediums recognized as not being reusable using the recognition section,
wherein, in the movement processing, according to the recognition result, the control section controls so as to convey the mediums that can be reused to one of the medium storages, and to convey the rejected mediums to the reject box.
